(19) United States
(12) Patent Application Publication
(10) Pub. No.: US 2020/0245828 A1
(43) Pub. Date: Aug. 6, 2020

(54) Toilet Seal

(71) Applicant: Aristo Crapital LLC, Bartlett, IL (US)

(72) Inventor: William Bahn, Bartlett, IL (US)

(73) Assignee: Aristo Crapital LLC, Bartlett, IL (US)

(21) Appl. No.: 16/265,596

(22) Filed: Feb. 1, 2019

(51) Int. Cl. A47K 13/24; F16J 15/02; F16J 15/00

(52) U.S. Cl. CPC A47K 13/24; F16J 15/002; F16J 15/027

(57) ABSTRACT

Incorporation of a materially superior hollow rubberized compressible seal (not the animal) into the seat and lid components of a toilet, thereby forming an improved air seal of the toilet bowl compartment and curtailing exfiltration of contaminated air and vapor through the nominal gaps between the lid and seat, and between the seat and bowl rim. The intentions of this historically significant advancement in toilet technology are to raise the standard of living for all of humanity and to enrich the inventor financially.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Toilets having operable lids and seats to accommodate most sitting, standing, and kneeling positions of the user are generally known in the art and have numerous uses and features.

Toilets broadly manufactured and employed today may aptly serve the primary function of receiving bodily waste and evacuating it from the domicile via a series of tubes, where it is then diverted to a municipal sewer, private septic system, neighbor's swimming pool, or nearby pond. This dusty, mummified archetype of cultus commodus functionality has been neglected for over a century. When the wheels of history, consciousness, and justice slowly turn and we begin to contemplate toilet aptitude against even a slightly elevated modernized standard, then a rational and informed observer might conclude that the entire world's inventory of toilets remain wholly and grievously defective.

Mass-produced toilets widely used today and the current state-of-the-art toilets are designed with flagrant deficiencies in their ability to prevent contaminated air, vapor, and particles originating and agitating within the waste-collecting bowl space from escaping out to the surrounding environment. Consequently, people, pets, and normal household items within any relative proximity to the bathroom are forced to breathe in the bio-waste vapor and/or being continually coated in microscopic layers of fecal matter and other organic refuse particles. This phenomenon, were it more universally recognized, may qualify for human rights abuse claims in advanced nations, thus necessitating the use of federal emergency funds to mitigate what is essentially the perpetual bio-chemical bombardment of our citizens. Among a small cadre of concerned lavatory inventors, those few who have heroically attempted to solve the issue have been vanquished and condemned to the gaseous swamp of historic obsolescence.

The new product introduced herein advances, at long last, the state of the art towards resolution of this issue by materially enhancing the modern toilet's ability to restrict air, vapor, and particle transmission outward from the bio-waste receptacle, and thus better protecting proximate objects and life forms from exposure thereof. It should here be noted that some property managers and owners, in an effort to save tens of dollars, will install embodiments of toilets that incorporate solely the seat and forgo the operable lid in their public restrooms. The new invention provided herein will still work as described if the seal system is properly utilized on the underside of the toilet seat and the user's immense girth, when seated, adequately covers the designed waste-passthrough hole in the middle of the seat.

Ever since human civilization collectively decided to take the theretofore mundane alfresco act of urinating and defecating in outhouses or leaf piles in the forest and relocate these bodily waste excretion operations indoors, into the same domicile enclosures where family and loyal pets sleep and eat, people have agonized over the consequences.

The contemporary paradigm of toilet use is founded, as principal net benefits, on being no longer required to 1) walk outside during hostile brown bear mating season, nor 2) dig new “shit holes” on a neighbor's property (the resulting conflicts of which may have led to the mid-century fence proliferation in American suburbs). These known advantages theoretically supersede the drawbacks associated with bringing bowel-voiding activity indoors. Such deficiencies include the unpleasant, and potentially hazardous, countenance of knowingly and unavoidably breathing in the airborne fecal matter generated by anyone who happens to defecate nearby. Furthermore, all objects within a disturbingly large radius of the toilet are being continuously coated in dross particulate, including any E. Coli bacteria riding the microscopic feculent comets, with long term exposure forming a measurable veneer of encrusted excreta on all exposed walls and objects (e.g. tooth brushes and family portraits). It is therefore abundantly clear that the widely celebrated human achievement of Being the Only Species on Earth to Defecate Where They Eat (or adjacent to where they eat)—despite prevalence of idioms and fables urging otherwise—is far from a perfect system and improvements are still gravely necessary. If we, collectively, are going to continue to defecate within the same confines as our precious family and stockpiled produce, then decisive and long-overdue improvements to this otherwise grotesque self-abasement are desperately needed.

Base designs of widely produced and presently adopted toilets are negligent any technical effort toward containing the air and vapor that are contaminated within the toilet bowl during the toilet's use in collecting waste. Commonly utilized toilets therefore provide only minimal protection against the exhaust of this contaminated air during the turbulent flushing process if both the lid and seat are down and functioning as a deflector shield to parry the billowing mushroom cloud of vapor and particles exploding from the bowl pit. The vast majority of toilets in the worldwide market are impaired with complete annular gaps between the full circumferences of the toilet bowl and seat, and the seat-to-lid, thus perpetually allowing a clear and voluminous path of air transmission from within the bowl to the surrounding environment at all stages of use: inactivity, bowel voiding, and flushing—even when the seat and lid are both closed.

Original art for toilet (or “water-closet” during the era where apartments were so spatially limited that people ostensibly stored clothing inside their toilets) seats (e.g. U.S. Pat. No. 749,083, McElroy) and lids (e.g. U.S. Pat. No. 3,484,876, Thomas) included physical standoffs, rubberhead screws, or other means of point-load supports where the seat makes contact with the upper rim of the toilet bowl, and also where the lid makes contact to the topmost surface of the seat. Subsequent toilet and toilet-related art have incorporated this concept and some form of this standoff/separator design exists on most if not all toilet seats and lids in service today. These standoff buffer nubs raise their respective components slightly, thus creating circuitous gaps between the toilet seat and the upper rim of the toilet bowl, and also between the toilet seat and the toilet lid. These gaps are duly illustrated on much of the prior art—egregious design flaws bedeveling all olfactorily imaginative observers of patent details. These circuitous gaps are problematic in that they provide the means for substantial air transmission from inside the toilet bowl towards the outer atmosphere, where the discharged noxious gasses are then free to migrate and contaminate nearby objects, animals, food, eating utensils, and people.

Even antique obsolete toilet or water-closet lid art where standoffs are absent and the lid makes theoretical continuous contact with the bowl rim, while good-naturedly (and likely unintentionally) reducing the nominal gap between the rim and the lid, still omit compressible materials between these components and thus cannot sufficiently function as a vapor seal nor manage the exfiltration of air and particles from within the bowl through imperfections and long-term warping of the toilet seat. Deformable, compressible air-barrier materials that automatically return to shape, such as those comprising the skulls of classic He-Man™ toys, are therefore optimal and necessary to fill the variable gaps between the ordinarily solid seat, lid, and bowl elements.

Throughout human history, up to and including the moment when the present invention herein is manufactured and implemented, people have glumly accepted the frequent gassing of their domicile and faces with intermittent blasts of aerosol fecal waste as a melancholic fact of life. Lifelong exposure to feces particles from every inhabitant, guest, or Irritable Bowel Syndrome Burglar is acquiesced to be an eternal curse of the human condition, forever plaguing every man, woman, and child without prejudice or mercy.

In what may stand as a damning indictment of humanity's depleted will to live and collective lack of ingenuity and resolve, the definitive solution to this universal scourge has heretofore remained elusive. The most universally adopted makeshift contrivances meekly engaging this worldwide bio-gas exposure crisis include ceiling vent fans, the deceptively labeled “air fresheners,” and lit matches.

Ceiling fan ventilation in bathrooms is widely utilized and known in the prior art. These are inherently simple Neanderthalic Science Fair attempts to solve the problem; any ape descendant can mistake a prolonged aneurysm for profound epiphany and edit the ensuing vomit of thought fragments into a 10,000 word patent that can be accurately summarized as “duct tape a vacuum to the ceiling.”

One example, U.S. Pat. No. 9,022,846, Lawrence Tom, is generically representative of the ceiling vent fan concept as a whole and, in spite of the public fondness afforded inventors with two first names, is unfortunately doomed by its deficiencies in addressing the myriad troubles aroused by airborne toilet contaminants. The encumbrance imposed by this device vis a vis its electric power requirements adds cost to the user, fire risk, and also the risk of failure during a brownout (an energy dilemma that is curiously overlooked in the majority of toilet fan art, despite the outstanding pun potential afforded, opportunities for which are not frequently missed by your humble inventor here). For the user, then, life considered in aggregate may in fact be measurably improved when these devices are disabled and the costs and risk factors are annulled. The ceiling vent fan operates by drawing air from the bathroom (or whichever presumably bodily-waste-voiding room in which the user has installed it) thus creating a pressure draw resulting in gentle air current winding through the room. Consequently, the suction and air current forces that are generated by these devices may in fact exacerbate the expulsion and accelerate the spread of atomized waste particles and vapors exhausted by the toilet bowl. Even when the vent fan is working properly as intended, it is sucking aerosol fecal matter into an adjacent vent or wall cavity, where it is then free to accumulate in a concealed, inaccessible, impossible-to-clean space where the resulting aggregation continuously radiates foul stench until eventually igniting. If someone were to invent some kind of removable and cleanable or replaceable fog-filter for ceiling fans, then this one singular objection might be mitigated (side note: I hereby reserve the right to a placeholder patent application for toilet ceiling fan ventilation filters via this parenthetical sentence, to the greatest extent that such a filing is possible), but the device concept in whole and spirit is still an abortive failure in design and implementation. It is therefore preferable, rather than to encourage farther and faster travel of escapist aerosol fecal matter and other toilet vapors by creating air flow and pressure differentials within the lavatory, to implement a solution that smothers the contaminants at the source—within the toilet bowl—to guard against their escape and protect immediate surroundings from exposure.

Another known and somewhat widely adopted response to the epidemic discharge of aerosol fecal matter from toilets is a device marketed as an “air freshener.” These devices are commonly known in the art and, upon even the most basic and common-sense analysis, are objectively horrible domiciliary chemical-emitters that defy all rational consideration.

One such example is U.S. Pat. No. 7,540,473, Schwarz. This device and variants thereof are commonly known in the art and widely used today. Generally, “air freshener” devices dispense an evaporating volatile liquid via heat diffusion or a small motorized fan, which generates an air stream and distributes the chemical emittance out to the immediate surroundings. This solution is representative of humanity's collectively vapid crisis response administration; over 100 years of spritzing our lunch and children's faces in gaseous waste has inspired a defense whose synopsis could be aptly titled Spray Even More Stronger Gas (SMEGMA). “Air Freshener” designs are universally lazy in concept and origination in that they endeavor to cover and conceal the problem (unwanted scents) rather than rooting out and addressing the source. Rather than eliminate the airborne contaminants, or prevent them from traveling freely through the domicile, these devices release globules of airborne materials to overpower, in smell and sometimes feel, the toilet vapors. Consequently, household inhabitants are not only continuing to breathe in microscopic fecal particulate, but are now also inhaling whatever perfumed chemical cocktail is dispensed from the “air freshener,” thereby coating the person or domesticated animal's lungs with inorganic compounds (including—if a shrewd distributing corporation were so inclined—mind control fluoride or vaporized methamphetamine). This device, and others like it, maliciously appeals to the dystopian post-middle-class American population's want and capacity to delude themselves into believing that they don't live in a revolting goblin nest lined with sports memorabilia and yellowing newspapers.

Another common and widely utilized scent-masking device is the Lit Match. LMs actually work pretty well in mitigating the olfactory affront of airborne fecal matter. However, this benefit comes at significant cost by requiring the user to expend some physical labor (match-striking) and purchase a new match after each use. It could be argued that LMs unnecessarily elevate the acute risk of fire hazard, given that the median American lives in a driftwood storage container filled with oil-soaked sweatpants and cheeseburger wrappers, however, a more cunning analyst might recognize this perilous eventuality as a net-benefit because, until the existence of the present invention herein, the only guaranteed way to totally avoid airborne human fecal contaminants was to die in a fire.

There is therefore an extant need for a latent solution, a vigilant Lavatory Knight guarding against erupting toilet bowl vapors during all hours, without the need for regular maintenance, that will not coat inhabitants' respiratory system in harmful chemicals, does not require costly energy to function, is inert, and does not present a considerable risk of burning down the domicile and incinerating its inhabitants while they sleep.

One frequently designed (though not adopted) yet misguided approach to manage contaminated air has been the fanciful contrivance of an exhaust ventilation system installed within the toilet bowl itself.

The use of a ventilated toilet apparatus is known (mostly by those who spend their time researching toilet patents) in the prior art, and these devices generally attempt to address contaminated toilet bowl air exfiltration by maintaining consistent negative pressure within the bowl cavity. In utilizing suction to capture and divert the air and particulates from within the toilet, the contaminated vapors can then be vented to some other space (presumably a different room). There exist a variety of patented systems devised to vent and exhaust the malodorous toilet bowl air utilizing hosing, varieties of vent and fan placement, toilet seat ductwork, and other means. While, in theory, these devices and accessories might capably draw odorous air from the toilet bowl, few if any address the myriad difficulties of managing that putrid air after it has been extracted. To wit, after the polluted toilet bowl air is sucked into the device, where does the ventilation exhaust duct then lead? Does it simply discharge the feces-saturated air into the attic and attract swarms of bats? Does it seep sewer gas into baby's nursery? Does it accumulate in the adjacent wall cavity and make the entire house smell like it is haunted by a Fecal Ghost? These questions remain insufficiently answered in the art and, in combination with the exorbitant costs to execute, render these theoretical air-suction solutions unfeasible for widespread use today. These options will hopefully someday, likely well after relevant patent terms expire, be more cost effective in a Utopian future where technological advances have made intra-toilet air exhaust or waste teleportation infrastructure more cost-effective to implement on a mass scale (for the lack of present viability, however, these inventors might as well have spent their brainpower designing E. coli-targeting under-seat mounted laser systems). Until such time, it remains an exigent need to devise a prudent stopgap solution for mitigating contaminated toilet air migration.

Known prior art for toilet bowl ventilation systems include U.S. Pat. No. 4,617,687, Wadsworth; U.S. Pat. No. 4,175,293, Stevens/Nielson; U.S. Pat. No. 5,355,536, Prisco; U.S. Pat. No. 5,161,262, Quaintance Sr.; and U.S. Pat. No. 5,125,119, Munoz. In addition to the prohibitive cost-inefficiency of these designs, the lack of any schema for air flow logistics betrays the inventors' quiet acquiescence that these ideas are exhaustively useless; a capitulation to the reality that their entire life's work amounts to designing a toilet upgrade for the Millenium Falcon™ that is so thoroughly irrelevant as to be rejected by even the impassioned Star Wars™ Mechanical, Electrical, and Plumbing fan-fiction community (where competing theories deliberating cast-iron pipe's structural failure rate under Wookie load volume far supersedes any debate with regards to gaseous particulate management—further evidence that the issue was still unsolved a long time ago in a galaxy far, far away; reference relevant Corellian Engineering Corporation YT-1300 specifications).

Further, many of the aforementioned toilet vent designs fail to address the catastrophic failures that would surely result from even a single occurrence of toilet overflow, something that is statistically likely to happen more than once during the life cycle of the average toilet. In the case of abandoned patent application U.S. Pat. No. 11,895,606, Pham, for example, an overflowing toilet might dump feces-saturated water, clumps of toilet paper, paper towels, and tampons into the air duct exhaust system. From there, the feces can migrate freely through the duct system (infringing on copyrights for the movies Die Hard™ and Alien™, if still in force—yet another costly liability unaccounted for in the cost-benefit analysis of these designs) or leak into the wall cavity and beyond.

Apart from the device's encumbrance of significant cleaning and maintenance challenges for the toilet's end user, the likely feces water exposure also has the potential to short-circuit the exhaust fan on electric-powered embodiments. Even worse, any unwary patron attempting to de-clog or clean the toilet might be electrocuted by the live wires and fan motor flooded with “gray water.” None of these design proposals adequately assuage the concerns raised by the well-founded safety risks associated with mixing electricity and diarrhea.

Further, the concept of fan driven, ventilated toilet bowl systems and the associated extra-domicile ventilating required to make these concepts work is cost prohibitive, in the current and foreseeable environment of toilet-related ventilation and power technology, relative to the limited and unverified theoretical benefits offered. It is therefore preferential to offer another, more cost-efficient toilet-air management option in the interim while we wait for technology to significantly improve—a wait that unfortunately never seems to diminish as horribly misguided and misshapen inventors abandon pursuit of cutting-edge battery tech to endlessly tinker with modifications that incorporate solar and bicycle power into their toilet exhaust fan designs, further obliterating America's position as a world innovation leader. Beyond all of the objective criticisms and shortfalls leveled above, a plurality of these design submissions are effectively rube-bilking planned obsolescence because electric grids are going to disintegrate in the nuclear inferno of an exploding sun well before any of these inventions are actually deployed on a single toilet.

To reiterate, the issue is of historic significance, for both immediate needs outlined herein and the impending future where a majority of the human population lives in re-purposed “big box” retail spaces with shared communal “open concept” toilet areas. Until powered toilet ventilation technology becomes efficient to implement (which will never happen), humanity needs a cost-effective stopgap solution for mitigating much of the contaminated air migration through the gaps between the toilet seat and lid and between the seat and bowl rim that occurs during and after use and, especially, when the toilet is flushed. The most appropriate and cost-effective solution for present day America is an invention that manages to effectively close off the designed gaps between the bowl and seat, and the seat and lid, thereby mitigating the exfiltration of desecrated vapors from within the toilet bowl cavity.

In addition to providing a toilet bowl air management system option with extremely favorable cost-effectiveness relative to all prior art, the new perimeter seal solution provided herein offers additional benefits and differs substantially from any and all existing toilet-related air management technologies and concepts.

Articles and devices for providing a sealing arrangement between two surfaces are known in the art, albeit not well known. There exist a variety of gasket shapes, seals, materials, attachment modes, and combinations thereof for numerous applications. For example, gasket assemblies existing in the art to form weatherstrips on window and curtain wall systems; gaskets to seal car windshield glazing, and gaskets to seal food containers are all well known and common. This aforementioned art and similar systems are designed to protect interior surfaces from exterior environmental conditions. However, the sealing arrangements of prior art do not adequately satisfy the specific need for an air seal to reduce or eliminate the exfiltration of contaminated air from within the waste receptacle of a toilet bowl.

Generally, the gasketing and sealing presented by prior art does not sufficiently address the specific need to form an air barrier between operable components—specifically the seat and the lid and the bowl rim—of toilets in a cost-efficient manner that may be easily adopted in modern times. Prior art embodiments that make this attempt all omit any use of advanced modern hollow-core rubberized gasket technology, and they definitely make no mention of utilizing two rows of annular seal.

Prior art that has in some way illustrated a seal applied to toilet systems are fanciful cartoon half-measures that ineptly differ from the present invention in 1) the attachment means, 2) the gasket seal shape and/or makeup, 3) the quantity of air seal lines, and/or 4) accommodation for varieties of toilet seat and lid characteristics. All prior existing art falls short of maintaining an optimal balance between reasonable feasibility on modern toilets and potential air barrier performance. Other attempted toilet seal designs are moreover independently suboptimal, generating a raft of new issues that altogether render the comprehensive totality of prior art a colossal failure.

U.S. Pat. No. 654,301, Barnes, includes a “soft-rubber gasket” seated within the toilet lid. The gasket, being “seated” into the lid component both a) applies solely to a seal under the toilet lid and makes no mention nor accommodation for a gasket beneath the operable seat component (thus leaving a sizable path for air exfiltration) and b) forebodes problematic and questionable longevity because the gasket is pressure-fit into a squared, equally shaped, and uniformly sized notch in the lid with no structural bevel capture and thus is prone to detachment and falling out. A superior design (such as that which is provided in the present invention) would incorporate an adhesive attachment or formed shape to capture the gasket and minimize long term maintenance issues. The above referenced prior invention also achieves solely one level of air seal by attaching a “soft rubber” base, the profile matching the full width of the top of the bowl rim, to the upper edge of the water closet, thereby creating a continuous and firm bearing surface for the offensively undemocratic, suspiciously conciliatory, and ostensibly treasonously-labeled “crown piece.” The seal is also comprised of monolithic solid material, rather than a premium hollow-core pliable rubber shape. The superior hollow-core gasket technology may not have existed in 1899 when this patent was granted, or inventor Edwin S. Barnes may have lacked the prescience to consider the vast possibilities afforded by hollow gaskets in a toilet seal application, or he may have attempted to incorporate an embodiment with a hollow gasket shape but was violently interrupted by a mass of plague-infested crows. Regardless of the cause for omission, the fact remains that the resulting final patent grant overlooks both the dual-seal concept and the superior hollow-core gasket and is therefore a waste of space in the Patent Office archives, even if consigned to zero-cost digital storage. Further to consideration of the above noted issues, and likely rendering all of the above critique unnecessary, modern toilet designs render this art obsolete and in no way germane to the present application.

U.S. Pat. No. 218,894, J. E. Morrison, includes a ‘T’ shaped gasket molded to fit snugly into the interior rim of the commode, or water-closet. The art provides neither illustrations nor prescriptive written means of attachment for the ‘T’ gasket to the operable lid. It should be noted that some college students drinking recreational chloroform in the 1890's reportedly claimed that there was an eerie alignment of thematic elements if you listened to “Down Upon the Suwanee River” by Professor Baton's Brass and String Military Band while simultaneously reading the J. E. Morrison patent aloud. This solid ‘T’ shaped seal provided here is also problematic in that by fitting snugly into the sides of the bowl rim it may be too tight of a seal and would therefore create pressure equalization issues during the flush process—i.e. a negative pressure suction in the bowl that impedes the rapid evacuation of liquids and solid materials in the bowl. The lapse in pressure government is a likely result of this invention being designed primarily for chamber pots in the era preceding indoor plumbing. This composition, as rendered by J. E. Morrison, also does not include accommodations for gasket seals at the operable seat due to the fact that an operable/lift-able seat does not exist in this art. The ‘T’ shape of this gasket would also warp and deform over time, reducing effectiveness due to the need for perfect pressure-fit on the interior surface of the toilet bowl. In addition to consideration of the above noted issues, modern toilet designs render this art obsolete and not at all applicable.

Prior art that has acknowledged the modern components of toilets (specifically both the operable lid and seat), and also attempted to incorporate some form of seal material within the gaps between the bowl, seat, and lid components, has ventured to do so in impractical, ineffective, or even hazardous machinations.

U.S. Pat. No. 9,265,390, Dillard, features add-on attachments with integrated gaskets mounted to the upper rim of the toilet bowl and the toilet lid underside. Unfortunately, as summarized below, this design may be more appreciated as neo-romantic liberal art than as functioning latrine utility patent art. The patent application was likely submitted as a desperate last-ditch effort to force a captive audience to look at these drawings because—when your lifelong dream of being a toilet sketch artist has flushed you down into an illegal basement apartment on skid row, and you've been turned away by every art gallery in town, and even the internet algorithms are deleting your drawings to save server space and bandwidth—at minimum one statutorily-mandated soul in the U.S. Patent Office is legally required to evaluate your work when submitted with the relevant fees. It could then be argued (though the present inventor will remain objective and without comment) that this is yet another example of a wasted humanities education undermining the resplendent utilitarian efficiency of the U.S. government. To achieve a single seal (rather than the objectively superior Double Seal provided in the present invention) in the space between the toilet bowl and the toilet seat, the Dillard art specifically attaches a flap seal (or “upstanding finger” according to the invention's anatomically replete description) to the top of the toilet bowl rim, rather than the underside of the toilet seat. The add-on attachments of this design do not appear easily adaptable to the wide variety of toilet bowl, seat, and lid shapes populating the big box appliance retailers and underground American toilet bazaars, and thus not easily conformable to the variable gaps between those components. The attachment means of this design also do not seem to accommodate for the presence of standoffs beneath both the seat and the lid integral to the majority of current in-use toilet designs. Additionally, this Dillard invention will unfortunately beget numerous crevices and soft, fertile overlay where bacteria and other toilet bowl materials might flourish on what are otherwise typically smooth, hard porcelain surfaces. These gratuitous cracks and gaps between the “coupling components” gripping the bowl and seat will be difficult to clean and therefore potentially exacerbate enduring unwanted scents. These “coupling components” create large surface areas of elastomeric materials that will have disparate stain resistance properties compared to coated ceramic surfaces or plastic common in most toilet designs. This will, unfortunately, increase the long term maintenance and cleaning costs associated with the toilet, which will have to be weighed against the benefit of the air seal performance, which is already sub-par now that par is defined as the Double Seal provided for in the present invention. The primary seal between the bowl and the seat devised by the Dillard art mounts to the top of the bowl lip, which unfortunately is then more prone to splash exposure of waste materials—not least of which while the seat is raised and a person is urinating while standing over or adjacent to the bowl, but also during splash-heavy defecation bursts. It is therefore preferable, for this and many other reasons, to mount the gasket to the underside of the seat and underside of the lid so that they are generally spared from splatter when raised during stand-up urination. In light of the above noted issues, the Dillard Toilet Seal System art is probably the best-drawn, most valiant attempt existing in the toilet seal art and yet a wholly unusable failure.

In the abandoned, un-granted U.S. Patent application No. 20,050,138,721, Bowman, the design proposes a languid and sophomoric sketch where one might surmise a generic notion to restrict the emission of water droplets between the toilet seat, lid, and bowl rim components with a singular seal system attached to the undersides of toilet seat and lid. This justifiably forsaken submission utilizes a vague solid material functioning as the seal, including dubious suggestions of “wood and “metal.” Coupled with the overly simple detail sketches, the peculiar specification of metal and wood seals therein is indicative of an application intending either to prefigure an elitist upper class market where highbrow pompous anuses prefer their gasket seal materials to consist of gold and custom stained mahogany (which, over time, will allow some air exfiltration due to wood's inferior air-seal properties, thus violating the user's false sense of air-purity and frequently dusting his or her glass of 18 year scotch with airborne fecal particulate), or a post-A.I.-singularity future where Terminators™ overwhelmingly prefer steel toilets. This may also be but one example of the many Patent Trolls attempting to advance the decades-long siege of the art kingdom of toilet air seal design science. The broad, unspecific banality of this forsaken patent application is analogous to a devious conspiracy to leverage the U.S. government into extracting Intellectual Property Damages from school children by patenting a broad range of sandwiches. Even if that weren't true, solid materials are cost prohibitive and ineffective compared to the hollow-core gasket technologies that are central to the present invention submitted herein. Further, this Bowman application appears to have originated in the United Kingdom and thus, understandably, does not account for the distinct unholy proteins of American diets and consequent feces acidity and yield. Ergo, the rejected application naively includes only one line of seal, whereas a second backup gasket seal line would be preferred for containment of the aggressive American biotoxins. This abandoned, not-granted application is also vague in attachment means for the seal material, and, further to the explanations for vagueness and design deficiencies outlined above, is possibly therefore simply rote plagiarism of similar art present in U.S. Pat. No. 654,301, E. S. Barnes, patented on Jul. 24, 1900. Alternatively (and in this writer's view necessarily plausible for reasons including evasion of slander law), the inventor Bowman is actually a reincarnated (in the Greek metempsychosis variant) E. S. Barnes who has retained only faint vestiges of astral consciousness (phantom urges and fears, desires unmoored from modern societal guidance, spectral daydreams of black lungs, gangrenous amputations, and riding horses) from a previous life and yet preserved the core essence of his soul—the primal need to add gasket seals to toilet seats—which is so subconsciously imperative that it compels the otherwise oafish husk of a man to draft a patent application in this arena.

U.S. Pat. No. 3,593,349, Bungo “Whisper Seat,” provides for a large ovaloid flat member attached to the toilet seat undercarriage and, according to the patent language, is primarily intended to mute the acoustical disturbances of concussive flatulence common during defecative toilet use. This device may also be impregnated with flowery oderant. This device's specifications and art, as so many prior designs have mistakenly stipulated, utilizes a solid material and is differentiated by being a singular monolithic slab of perfumed plastic sized to nearly the full width of the seat rather than the objectively superior one or two annular rings of a hollow-core gasket. The Bungo Whisper Seat also does not accommodate for the standoffs present on seats and lids commonly in use on most toilets. In order for this device to function on most toilets, the standoffs would have to be removed from the seat, or the Bungo acoustic seal will have to contain hollow carve-outs to avoid or embed around those standoffs—neither option of which (nor any accounting for the lid and its standoffs) is described in the claims or description. Other than the supreme marketing advantage in the toilet and fecal defense products arena afforded by the inventor's name, this obsolete art is Mexican Minor League Baseball compared to the present invention's New York Yankees solution outlined subsequently herein.

In the abandoned, un-granted 2005 U.S. Patent application 20,060,206,998, Corbin, the art summarizes “Particulate Inhibiting Barriers for Toilet” and objectively falls short of providing an economically optimal and high performing solution for this stated purpose. Unfortunately, the illustrated configuration of the designed barriers being coupled or chained together (FIG. 5 in the application documents) completely neglects the presence of standoffs present on the majority of toilet seats and lids commonly in use today. To reiterate, the toilet seat standoff is an established and necessary evolution of toilet seat technology and allows the seat or lid to close with the standoffs absorb and transfer the seated user's weight loads at consistent, managed, engineered points, and these standoffs should be embraced rather than obliquely ignored in the design of any seat and/or lid based gasket seal system. As noted on much of the prior art discovery, there is a need for a new toilet gasket seal design to properly acknowledge and incorporate these toilet seat standoffs, rather than naively hope that they are eliminated in toilet products of the future. Further, there is no benefit to offset the negative consequences and costs associated with the coupling of numerous smaller gaskets married together in lieu of one sleek, continuous, annular ovaloid gasket (the words “annular” or its misspelled homonym “analar” do not exist in the Corbin application). The proposed arrangements therefore introduce numerous gaps or “weak points” allowing potential for failure and air leakage. Additionally, the Corbin proposal appears to have originated in England and thus very likely does not take into account the many nuances of, and thus slight adjustments necessary for, the median bowel-voiding United States citizen. There is therefore a pressing need for the patriotic, American-made invention presented and summarized herein. Finally, this Corbin design also includes three embodiments of the “barrier” which are all some variant of an extended wiper-shape seal (FIG. 4C looks like it was borrowed from a child's Standard-Issue Book of Optical Illusions and Puns that all European youth obsessively read to avoid the horrors of their war-torn landscape) which tend to warp, curl, and generally deform over time, and all of which are objectively inferior to cylindrical or semi-circle hollow core “bulb” gasket designs that the present invention herein utilizes and the benefits of which are further summarized in the descriptions below.

Most or all of the prior art feebly attempting to incorporate a seal material on the toilet lid or seat are utilizing solid materials and thus, consequently, unable to efficiently accommodate the many nominal variances in toilet seat and toilet lid shapes and design. The gaps between the seat and lid will vary by manufacturer and region (Alabama toilets, for example, are notorious for having wide gaps between the seat and upper rim of the toilet bowl to elevate the user slightly and provide a meditative refuge evoking delusions of average human height and antebellum hegemony) and thus for much of the prior art a uniquely-sized “seal” would need to be fabricated for each small variance. There is therefore a desperate need for an American-engineered hollow bulb gasket yielding “one-size-fits-most-toilet-gaps” benefits provided in the present invention.

Finally, and most importantly, even if all of the above citations of prior art weren't pointless never-used failures, none of the above toilet seal embodiments, explicitly or implicitly, design for two lines of seal at each gap (between the seat/bowl and seat/lid, if applicable). The use of a hollow-core bulb gasket shape and the introduction of a secondary line of air seal are, individually, novel advancements in toilet seal art deserving of exclusive patent protections. When combined, they form the basis for revolutionary progression launching toilets like ICBMs headlong into the 21^{st} century. The new creation devised herein is the first and only art in existence to design two annular hollow bulb gasket seals at the underside of each surface (toilet seat and toilet lid, if applicable) to finally solve the dilemma of contaminated air exfiltration on toilet bowls once and for all.

### BRIEF SUMMARY OF THE INVENTION

In view of the foregoing disadvantages inherent in the known types of bathroom and toilet bowl air management systems and toilet bowl seal systems of known designs and configurations now present in the prior art, the present invention provides an economically efficient, objectively superior, and demonstrably improved toilet lid and toilet seat seal system with numerous advantages in containing and restricting the exhaust of the air and materials from within the toilet bowl space. As such, the general purpose of the present invention, which will be described subsequently here in greater detail, is to provide a new and improved toilet seal system which has improved upon the advantages of prior art, has adequately addressed the disadvantages of prior art, and has likely solved the contaminated toilet air dispersion issue with such thorough perfection that no further advancements in the toilet seal art will ever be necessary again.

Modern home designs, venting and fan technologies, and labor costs make any powered toilet bowl ventilation system economically unfeasible for all but society's most privileged. These high-tech approaches are theoretically noble endeavors to solve the problems of contaminated toilet bowl air and fecal particulate migration, but it is this inventor's cynical prognosis that such technology is being patented solely for use on long range interstellar transports when the aristocrats finally abandon Earth and leave the rest of us to perish in volcanic landfill explosions and hurricanes of battery acid.

However, until such suction, motorized fan, and exhaust device implementation becomes effectively and economically viable for mass scale toilet implementation benefiting a majority of the human population (i.e. forever/never), there remains a humanitarian crusade to provide an effective and highly affordable measure for every person, or, for future considerations, androids attempting to feign human behavior while infiltrating our society & infrastructure, to contain and minimize the exhaust of noxious aerosol fecal matter from the toilet bowl cavity between the nominal gaps between the seat to bowl and lid to seat during the defecation and flushing processes.

To accomplish this critically important objective, the present invention comprises an annular gasket seal positioned on the underside of the toilet seat. The seal may be positioned to align with the innermost edge of the under-adjacent toilet bowl rim, the outermost edge of the toilet bowl, or—for improved air seal performance—may be utilized as a novel and as-yet-unheard-of double seal: two annular rings positioned such that both of the gasket seals makes continuous contact with the toilet bowl lip. This patent application makes no accommodation for, and hereby waives any claim to, any embodiment where three or more annular rows of gaskets are used within the gap space (between the seat and bowl) because two lines of air seal are optimal for performance, feasible given the space constraints, and economical for cost. The idea of using three or more annular gaskets to seal the toilet bowl is an absurd notion and aesthetically displeasing to the savvy end user, and thus would be a total misuse of material. Any inventor's efforts to conceive of a three-line toilet seal configuration and generate a patent claim thereof would be a complete waste of time and resources that could be better spent in literally any other way.

Another important and differentiating object of the present invention is the the size, shape, and makeup of the gasket seal. The gasket seal profile is that of a downward facing hollow-core bulb of any color (including, but not limited to, the following: Red, Black, Turquoise, Heavily Vitamined Dehydration Urine Yellow, Zebra Stripes, or Custom Matched Toilet Lid), rather than a solid shape, is comprised of pliable material (e.g. silicone, ethylene propylene diene monomer, nylon, vinyl, silicone-coated silk) and of sufficient diameter to fill the nominal gap between the toilet seat and the toilet bowl when the seat is in the down (closed) position and the seal is compressed. No prior toilet seal art has comprised use of a hollow bulb gasket in toilet seat and lid air seals; the distinction is important not only for raw material cost, finished product weight, and optimal long term performance of the formed air seal but also to adequately differentiate this art from prior toilet seal designs.

Yet another object of the present invention is that a gasket seal may be placed on the underside of the toilet lid, in embodiments where the toilet includes a lid, positioned to align with the inner or outer uppermost edge of the toilet seat such that the seal makes contact with the seat when the lid is in the down (closed) position. If superior additional air seal performance is desired, additional annular rows of gasket seals may be positioned on the underside of the toilet lid so that there are two gasket seals between that space when the lid is in the down (closed) position. As noted above, this application abandons any claim of use for three or more rows of gasket seals because doing so would be a gross abomination of toilet seat seal design.

There has thus been outlined, rather broadly, the more important features of the present invention in order that the following detailed description thereof may be better understood and in order that the present contribution to the art may be better appreciated. There are, of course, additional features of the invention that will be described hereinafter and which will form the subject matter of the claims attached.

In this respect, before explaining embodiments of the invention in further detail, it is to be understood that the invention is not limited in its application to the details of construction nor to the arrangements of the components set forth in the following descriptions or drawings. The invention is capable of other embodiments and of being practiced and carried out in various ways that those experienced in the art may reasonably infer. Also, it is to be understood that the phraseology and terminology employed herein advance the exegesis and, in general, should not be regarded as limiting. The quantity of annular gasket rows employed by this design, however, is specifically limited to two (2) rows and this invention foregoes the Frankensteinian claim to any quantity of annular gasket rows in excess of two. The time, effort, and cost to patent an embodiment with three or more rows of annular toilet gaskets would, in this inventor's view, be a sad waste of the fleeting miracle of human existence.

As such, those skilled in the art will appreciate that the conception, upon which this disclosure is based, may readily be utilized as a basis for the designing of other structures, methods, and systems for carrying out the several purposes of the present invention—other than utilizing a third row of annular gasket per applicable surface. It is important, therefore, that the claims herein be regarded as including such equivalent constructions insofar as they do not depart from the spirit and scope of the present invention.

It is therefore an object of the present invention to provide a new and improved toilet seal system which has all the advantages of the prior art (including seal systems of known designs and configurations), is further improved on these existing designs with specific novelties, clarifications, descriptive prose, and features not found in prior art, and is without the disadvantages and/or design ambiguities of the prior art.

An even further object of the present invention is to provide a new and improved toilet seal system which is benefited from a low cost to manufacture and install either in a factory capacity or an on-site modification and improvement of existing toilets, and which the overall cost-efficiency of the invention substantially benefits the general public by at long last making economically viable the universal prospect of improving humanity's quality of life with enhanced toilet technology.

Finally, an object of the present invention is to provide a toilet seat system for reducing or eliminating the free exhaust of air from within the toilet bowl through the nominal and common designed gaps that exist between the toilet lid and seat and the seat and bowl that are present in current toilet models publicly available and commonly used across North America today, and achieving this lofty goal in a safe, sanitary, clean manner with the smallest possible economic impact to the end user.

These, together with other objects of the invention outlined throughout this summary and along with the various features of novelty which characterize the invention, are pointed out with particularity in the claims annexed to and forming a part of this disclosure.

It should be noted that during the process of seated defecation, when the lid is in the open or “up” position and thus not factoring into the air transmission performance of the system, this invention will still improve the overall airflow management of the toilet by maintaining a hermetic seal between toilet seat to the toilet bowl, thereby minimizing or preventing the transfer of air and fecal globules or other contaminants from inside the bowl cavity to the exterior via the gap between the seat and bowl. Because most toilet seats have designed central holes to allow a path for feces and urine and other waste from myriad orifices into the bowl, a complete seal during seated use will therefore rely on the user to close off any seat gaps with his or her body—a proposition that should be achievable for all but the smallest users and atypical, unforeseen toilet seat designs (if anything, toilet seat design progression—e.g. U.S. Pat Application No. 20,160,029,860—is only further supporting American usage trends). According to the CDC, 39.8% of United States adults age 20 or older were obese as of 2015-2016 (NCHS Data Brief No. 288, October 2017), a percentage that has been reliably increasing over time. This inventor has no opinion on the merits or exigency of United States diets and sedentary lifestyles. Rather, there is reason for heightened enthusiasm among those concerned with fecal air containment technologies as larger human bodies are objectively better at settling across the entire toilet seat and closing the central opening thereof more completely. Consequently, the percentage of United States users who will gain the full benefit of this toilet air seal system during seated defecation is substantial and rising.

### BRIEF DESCRIPTION OF THE SEVERAL VIEWS OF THE DRAWING

The invention can be better understood with reference to the following drawings and accompanying descriptions. The components in the figures referenced herein are not drawn exactly to scale; emphasis has instead been placed upon illustrating the principles of the invention. Moreover, in the figures, like-referenced numerals designate corresponding parts throughout the different views. The above mentioned and other features and objects of this invention, and the manner of attaining them, will become more apparent and the invention itself will be better understood by reference to the following descriptions of the embodiments of the invention taken in conjunction with the accompanying drawings, wherein:

FIG. 1. is a diagrammatic isometric perspective view of one embodiment of a toilet, known in the prior art, with both the operable seat and lid in the “up,” or raised, position, adapted to utilize the principles of the present invention on both the underside of the operable toilet seat and on the underside of the operable toilet lid

FIG. 2. is a diagrammatic isometric perspective view of one embodiment of a toilet, known in the prior art, with the toilet seat in the “down,” or lowered, position and the lid in the “up,” or raised, position, adapted to utilize the principles of the present invention on both the underside of the operable toilet seat and on the underside of the operable toilet lid

FIG. 3. is a diagrammatic isometric perspective view of one embodiment of a toilet, known in the prior art, with both the toilet seat and lid in the “down,” or lowered, position, adapted to utilize the principles of the present invention on both the underside of the operable toilet seat and on the underside of the operable toilet lid

FIG. 4. is a side, or profile, view of one embodiment of a toilet, known in the prior art, adapted to utilize the principles of the present invention on both the underside of the operable toilet seat and on the underside of the operable toilet lid while both the seat and lid are in the closed, or “down,” position

FIG. 5. is a side, or profile, view of one embodiment of a toilet, known in the prior art, adapted to utilize the principles of the present invention on both the underside of the operable toilet seat and on the underside of the operable toilet lid during use while the user, representative of the median United States male citizen, is in the “seated” position, while the toilet lid is in the open, or “up,” position and the seat is in the “down” position

FIG. 6. is a front view of one embodiment of a toilet, known in the prior art, with both the toilet seat and lid in the open, or “up,” position, adapted to utilize the principles of the present invention on both the underside of the operable toilet seat and on the underside of the operable toilet lid

FIG. 7. is a front view of one embodiment of a toilet, known in the prior art, with the toilet lid in the open, or “up,” position and the toilet seat in the “down” position, adapted to utilize the principles of the present invention on both the underside of the operable toilet seat and on the underside of the operable toilet lid

FIG. 8. is a cross sectional view of the present invention toilet seal system shown in FIG. 3 and taken along line A illustrating one embodiment of the present invention attached to the underside of the toilet lid and to the underside of the toilet seat via receiver track

FIG. 9. is a cross sectional view of the present invention toilet seal system shown in FIG. 3 and taken along line A illustrating one embodiment of the present invention attached to the underside of the toilet lid and to the underside of the toilet seat via adhesive

FIG. 10. is a variant of FIG. 9. illustrating one embodiment of the present invention attached to the underside of the toilet seat and also to the underside of the toilet lid via adhesive, while in this illustration both the toilet seat and toilet lid are raised slightly to delineate uncompressed gasket seal shapes

FIG. 11. is a cross sectional view of multiple embodiments of the gasket seal exemplifying some of the core principle benefits afforded by the present invention

### DETAILED DESCRIPTION OF THE INVENTION

With reference now to the drawings, the preferred embodiment of the new and improved toilet seal system embodying the principles and concepts of the present invention and generally designated by the reference numerals 8, 9, 10 and 11 will be further described in more detail.

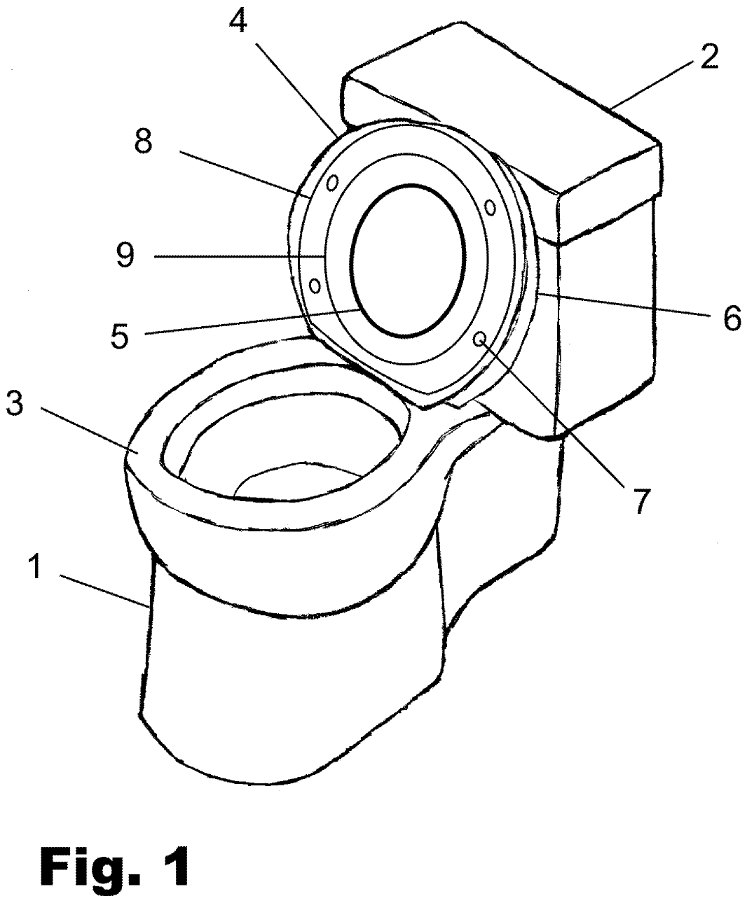

Referring to FIG. 1, first provided is one embodiment of a toilet, commonly known in the prior art (and, it should be noted, so commonly known that a detailed description thereof should not be necessary—the inventor therefore will forgo this outmoded status quo and omit detailed descriptions of toilets in an effort to keep the total patent narrative below 14,000 words and minimize the number of parenthetical, albeit grammatically stable, run-on sentences), designated 1 and shown in a configuration that includes a tank reservoir 2 (of no consequence to the claims herein but so labeled to direct attention towards the inventor's ability to draw schematically-accurate toilets) and both an operable toilet lid 6 and a toilet seat 4. The toilet lid is coupled to the toilet with a hinge connection on the toilet bowl's rearward hind quarters. The toilet lid may be raised or lowered manually, or via some mechanized means, or by a mysterious third party assistant that performs the motion in a secret way. The toilet seat is also coupled to the toilet with a hinge connection in the toilet bowls rearward position. The toilet seat may be raised or lowered manually or via some mechanized means.

Still further referring to FIG. 1, this detail illustrates an embodiment of a toilet 1 where both the toilet seat 4 and lid 6 are in the raised, or “up,” position. The toilet seat has a central hole 5 to allow a seated user's discharged waste materials free movement into the toilet bowl when the seat is in the lowered, or “down,” position. This embodiment of the toilet is depicted with the significant upgrade of the present invention, the superior improved toilet seal system comprised of two annular gasket seals attached to the underside of the seat as designated by the numeral 8 on the outermost circumference of the toilet seat and numeral 9 on an inner circumference of the toilet seat. Two annular gasket seals are also attached to the underside of the toilet lid (not shown, concealed behind the toilet seat). Note the annular gasket seal placement avoids the typical standoff 7 present on most toilet seats and lids known in the art. This overall isometric view of the toilet upgraded with the present invention here illustrates the toilet configured primarily to receive urine from a user standing adjacent to the toilet, or hanging upside down from the towel rod, or kneeling in front of the toilet expelling vomitus, neither function of which utilizes nor requires the air seal benefit of the present invention. The intent of perspective used in this depiction, however, is to exhibit the minimal aesthetic impact of the invention on the décor of a user's toilet even while not in service.

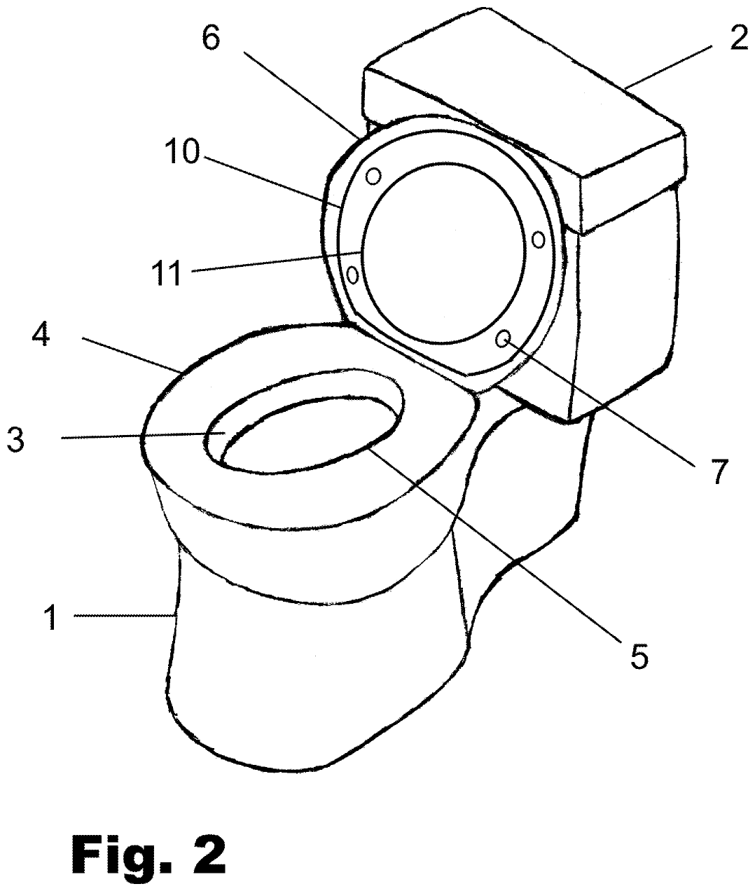

Referring to FIG. 2, this detail illustrates the toilet 1 (including a well-drawn toilet tank reservoir 2) presented as configured during use-mode where the user is in the seated position. Here, the toilet lid 6 is raised to expose the seat 4 and thereby provide a direct path from the user's orifices to the bowl cavity via the large hole 5 central to the seat. The toilet user is not illustrated on this embodiment both for clarity and because methods for using a toilet in the seated position are widely known and understood; those experienced in the art may, if so inclined, use their imagination to envision a person or anthropomorphic cartoon animal sitting on the toilet seat 4 and winking mischievously. This illustration shows annular gasket seals on the underside of the toilet lid 6, with one seal 10 on the outer circumference of the lid and one gasket seal 11 on an inner circumference of the lid positioned to make contact with the seat below and also avoid the typical standoff 7 commonly present on the underside of toilet lids. This embodiment of the present invention also includes a gasket seal between the seat and the toilet bowl (not shown here, blocked by toilet seat overhang).

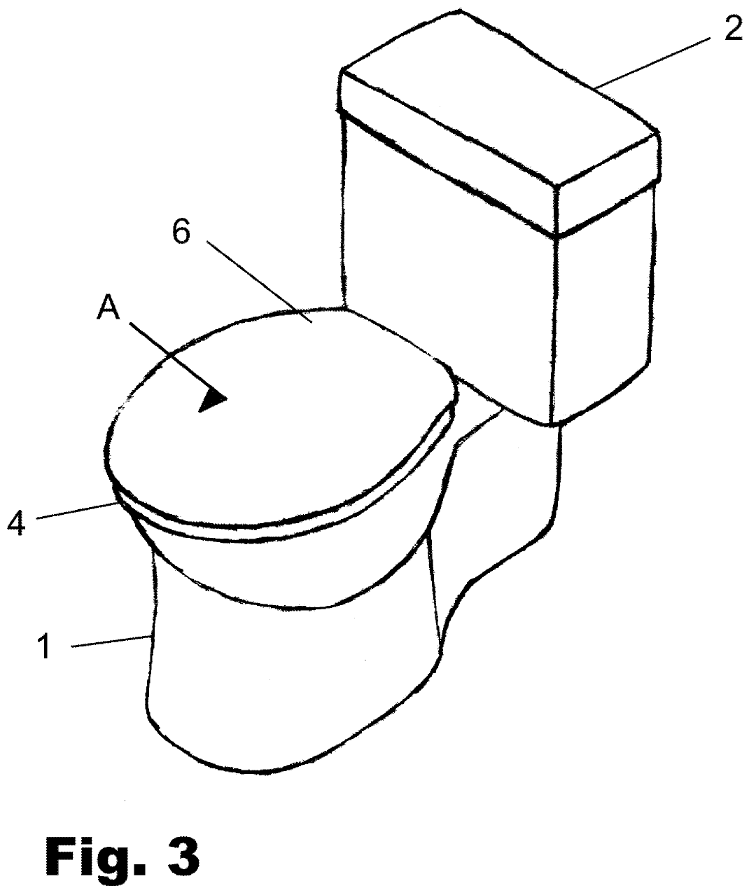

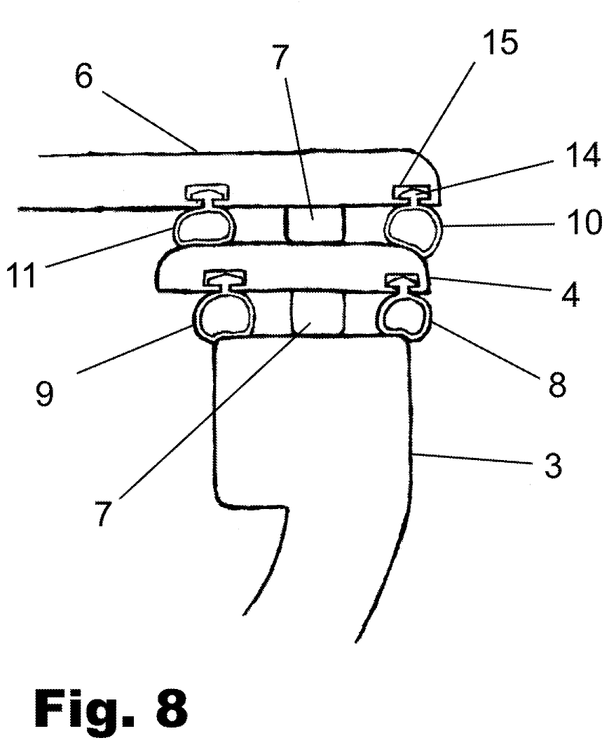

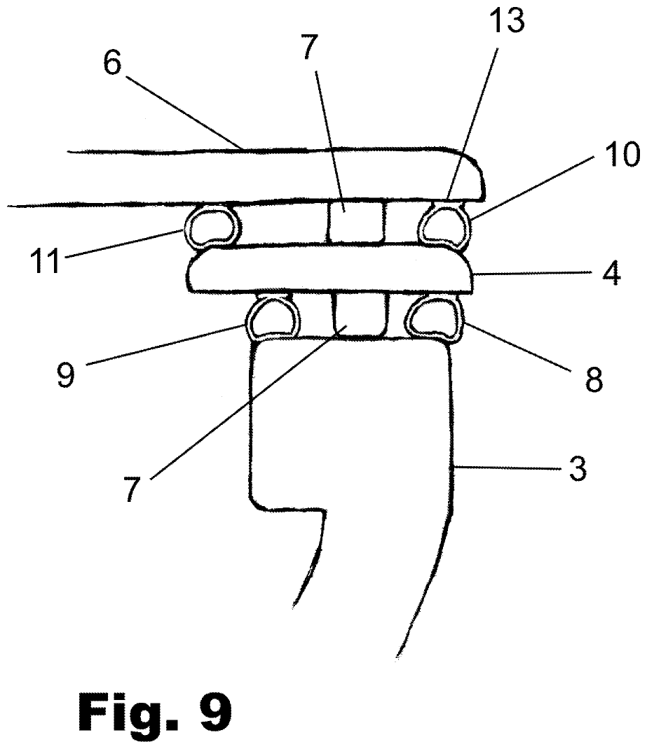

FIG. 3 illustrates a toilet commonly known in the prior art designated 1, ostentatious showcase of the perfectly-rendered hand-drawn toilet tank 2 notwithstanding, and shown in a configuration where both the toilet seat 4 and lid are 6 lowered or in the “down” position. This embodiment of the toilet is depicted with the significant upgrade of the present invention, two annular seals within the gap between the seat and toilet bowl (obscured in this detail perspective due to toilet seat overhang), and two seals within the gap between the lid and the seat (obscured in this perspective detail due to the toilet seat overhang). Section detail ‘A’ is also labeled here for reference and further elaboration in FIGS. 8 and 9. This overall view of the toilet upgraded with the present invention demonstrates the minimal aesthetic impact of the seat seal system presented herein, assuaging any fear that substantially increasing the performance of toilet bowl air management system need materially impact the overall décor or feng shuei of the end user's toilet room.

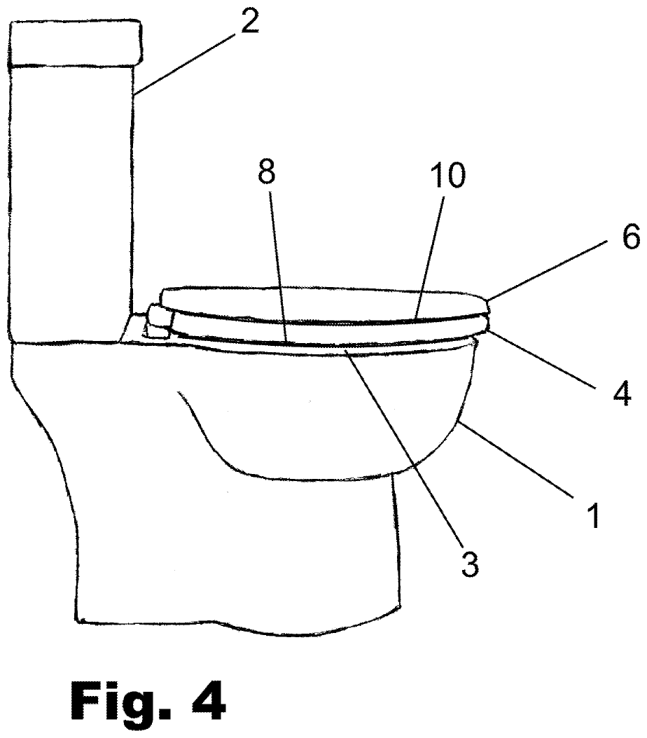

FIG. 4 illustrates, in a profile side-view, an embodiment where the toilet 1, utilizing both an operable seat 4 and operable lid 6, is resting in the “closed” position, where both the seat and lid are “down” or “closed.” In this embodiment, both the lid and the seat utilize the annular gasket seal provided in the present invention. The gasket seal between the lid and seat is barely perceptible, owing to the aesthetic genius of the inventor, and indicated by the numeral 10. The gasket seal 8 is present between the seat and the upper rim 3 of the toilet bowl. The toilet bowl and tank 2 are generally fabricated of a rigid ceramic material, but can also be constructed from gold or turtle shell.

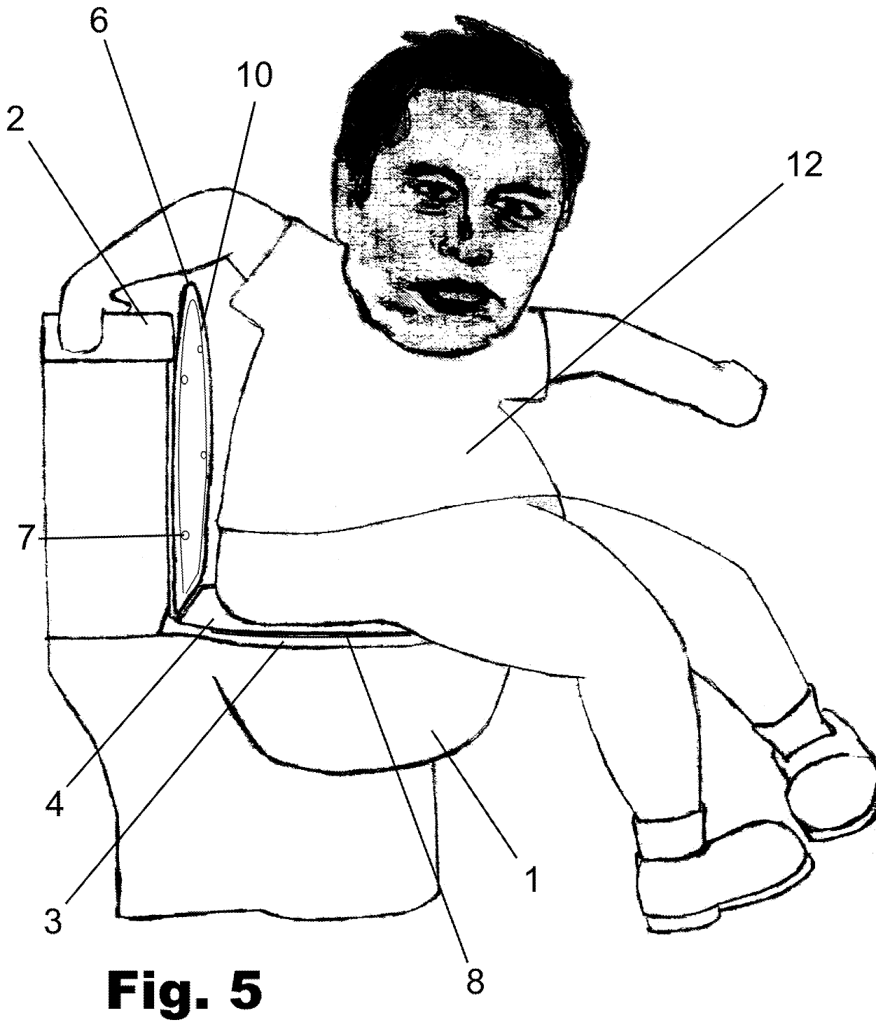

FIG. 5 illustrates an embodiment where the toilet 1, utilizing both an operable seat 4 and operable lid 6, is in use by a representation of the median American male 12 utilizing the toilet in the seated position. For this embodiment, the toilet lid 6 is in the up, or “raised,” position to expose the toilet seat 4, which is in the down, or “lowered,” position and provides a surface on to which the median American human may sit. In this embodiment, both the lid and the seat utilize the annular gasket seal provided in the present invention. The annular gasket seal attached to the underside of the lid is indicated by the numeral 10, and the toilet lid standoffs 7 (common on many embodiments of toilet seats and lids) are also visible. The annular gasket seal attached to the underside of the seat 8, and thus functioning as an air seal between the underside of the seat and the upper rim of the toilet bowl 3, is barely perceptible in this perspective image due to the seat overhang and distracting visuals of the erupting user. As should now be appreciated, the weight of the median American human is imposing downward pressure on the seat and this force is compressing the seals between the seat and the top of the toilet bowl rim. The human sealing over the top of the seat in this embodiment is representative of the median American male and, as such, possesses sufficient voluminous abdominal and anal immensity to assiduously cover the seat and form a reasonably effective air seal closing off the seat-hole (concealed).

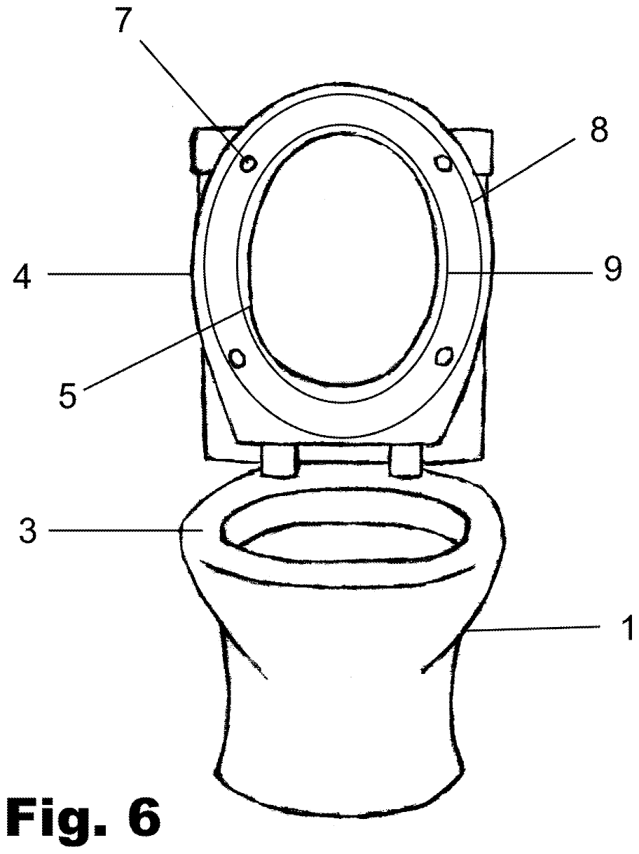

FIG. 6 illustrates a full frontal view of an embodiment of a toilet 1 with both an operable toilet lid (obscured in this perspective by the raised toilet seat) and operable toilet seat 4 utilizing the annular gasket seals 8 and 9 provided in the present invention. This illustration displays a configuration where both the toilet lid and toilet seat are raised or in the “up” position (note that the central hole in the toilet seat 5 is clearly shown and demonstrates the difficulty of drawing an oval free-hand), and exhibits this toilet utilizing an embodiment provided for in the present invention, with two annular gasket seals attached to the underside of the toilet lid (concealed behind the toilet seat, not shown) and two annular gasket seals attached to the underside of the toilet seat in positions that, when the seat is in the “down” position, will both make contact with the toilet bowl rim 3 below and also avoid the typical standoffs 7 present on most toilet seats currently in use today.

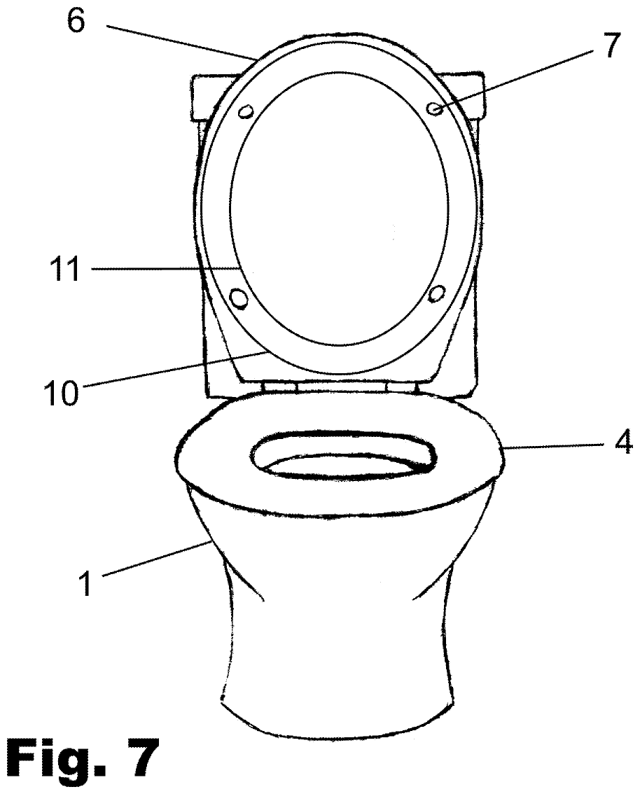

FIG. 7 illustrates a full frontal view of an embodiment of a toilet 1 with both an operable toilet lid 6 and operable toilet seat 4 utilizing the annular gasket seal provided in the present invention. This illustration displays a configuration where the toilet lid is in the raised, or “up,” position, and the toilet seat is in the lowered, or “down,” position, and exhibits utilization of an embodiment provided for in the present invention: two annular gasket seals 10, 11 are attached to the underside of the toilet lid in positions that will both make contact with the toilet bowl rim below and avoid the typical standoffs 7 present on most toilet seats currently used and two annular gasket seals attached to the underside of the toilet seat (not shown).

FIG. 8. includes a cross-sectional detail of the present invention's gasket seals 8, 9, 10, 11 functioning within (and labeled ‘A’ on) the embodiment illustrated on FIG. 3, where both the toilet lid 6 and toilet seat 4 are in the lowered or “down” position. The weights of the lid and seat alone are sufficient to compress the gaskets and form an air seal due to the relatively soft, pliable hollow bulb shape making continuous contact for the full circumference of the surface immediately below, thereby hermetically sealing the gap. The gaskets illustrated in this embodiment are attached to the underside of the lid and seat via pressure-fit receiver tracks 15—both the toilet lid and toilet seat have formed continuous annular notches or voids (“race” or “receiver track”) into which similarly sized and shaped portions of the gasket 14 may fit to prevent the gasket from falling out. This effective capture of the gasket holds it in place and prevents it from loosening or detaching from the seat or lid. This design also allows for the gasket to be removed from the receiver track with a pry or hook tool, enabling the user to install a new replacement gasket (if, for example, the user wants to use festive seasonal coloring and install “candy cane” gaskets on their toilet to impress guests during the winter holidays) in its place by applying pressure and pushing the formed “stem” of the gasket into the receiver track.

FIG. 9. includes a cross-section detail of the gasket seal 8, 9, 10, 11 functioning within (and labeled ‘A’ on) the embodiment illustrated on FIG. 3, where both the toilet lid 6 and toilet seat 4 are in the lowered, or “down,” position. The weights of the lid and seat alone are sufficient to compress the gaskets against the components directly below (the toilet seat or toilet bowl rim 3, respectively) and constitute an air seal due to the relatively soft deformable pliable hollow bulb shape, an important material fact providing for the proper function of the invention when both the seat and lid are in the closed position and no human or large child or animal or other weight is available to be applied to the top of the closed apparatus. The gaskets illustrated in this embodiment are attached to the underside of the lid and seat via adhesive. Because the existing toilet, seat, nor lid do not have a receiver track formed into the respective component to receive a pressure-fit gasket, this embodiment illustrates an alternate solution to utilize adhesive to attach the gasket seals.

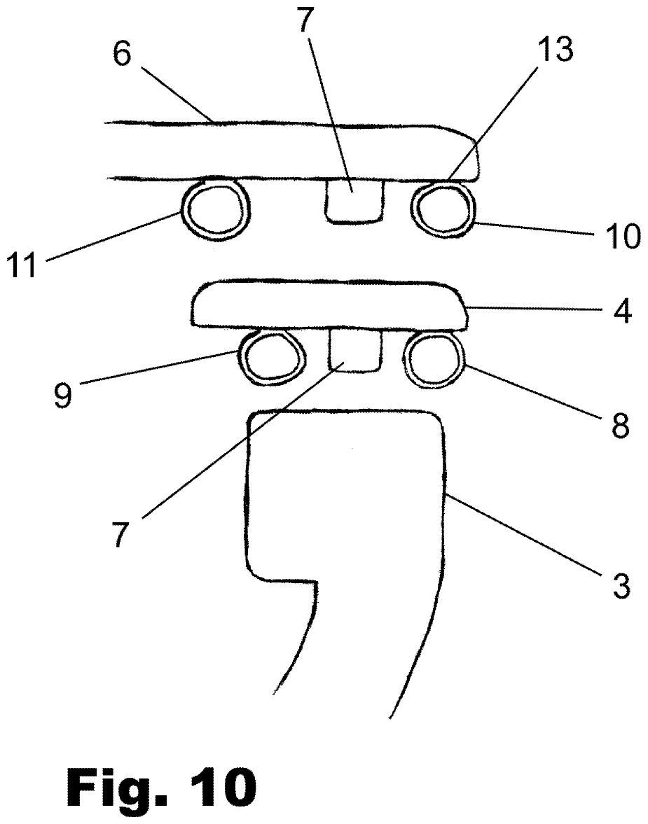

FIG. 10. includes a cross-sectional detail of the gasket seals 8, 9, 10, 11 attached to the underside of both the toilet seat 4 and toilet lid 6 similar to the embodiments illustrated on FIG. 9, with the slight difference in positioning of the toilet components. In this illustration, both the toilet seat and toilet lid have been raised slightly so that the gasket seals provided in the present invention no longer make contact with the surfaces immediately below (the toilet seat 4 in the case of the gaskets attached to the underside of the toilet lid, and the toilet bowl rim 3 in the case of the gaskets attached to the underside of the toilet seat) and thus the full shape of the gaskets are illustrated without deformation caused by compression after contact with these surfaces. Also note the standoff 7 illustrated beneath both the toilet seat and toilet bowl, in stark contrast to the omissions of toilet related patent pretenders prevalent within prior art and an important consideration for any gasket seal thus imagined on or around the seat and lid components. This illustration has been included for clarity and also to guard against patent gnomes who might argue that the shape of the gaskets in compressed form are somehow limiting in scope. The gaskets illustrated in this embodiment are attached to the underside of the lid and seat via adhesive at the designed flat surface 13 on the topmost portion of the seals, though the gasket seals may be attached by any reasonable, continuous annular method including those provided herein.

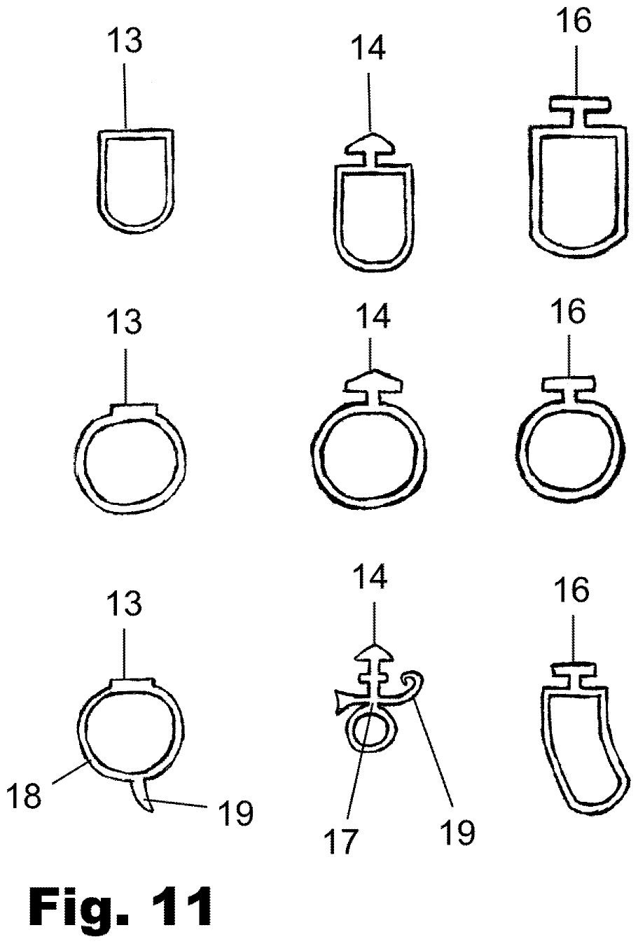

FIG. 11. illustrates multiple embodiments of possible gasket seal shapes and attachment means claimed under the present invention. All gasket options illustrated herein, and as claimed under the present invention, incorporate hollow bulb shapes to both provide the most cost-efficient pliability and performance ratios possible for any material utilized as a gasket seal in a toilet air seal application and also to adequately differentiate this design from prior art. Any combination of shapes illustrated herein, or similar shapes utilizing a hollow-core design concept, may be utilized as a gasket seal attached to the underside of the toilet lid (if applicable to certain embodiments of toilets) and/or the underside of the toilet seat. Three embodiments illustrated herein feature a flat contact surface 13 ideal for adhesive attachment to the underside of a toilet seat or toilet lid. The adhesive may be a pre-applied adhesive strip with a removable protective paper, or any other effective adhesive to be applied to this surface and attach the gasket to the underside of the toilet seat and toilet lid (if applicable). Three embodiments illustrated herein demonstrate a pressure-fit attachment system for connection to the underside of the toilet lid and/or toilet seat utilizing a formed extension 14 of the gasket consisting of a pointed “arrow” shape. The nub extension on these gaskets has an angled or “arrow” shape which makes the installation or fitting process into the similarly shaped and sized void (“receiver track”) in the seat and/or lid slightly easier than would a square shape, and retains stronger structural “pullout” values than ovoid shape. The nub extension may consist of the same material as the full gasket, or may be a continuously fused attachment of a sturdier, more dense material like vinyl or bone. Three embodiments illustrated on FIG. 11 demonstrate a pressure-fit attachment system for connection to the underside of the toilet lid and/or toilet seat utilizing a squared shape extension 16. The nub extension on these gaskets has a squared shape designed to fit into the similarly shaped and sized void (receiver track) in the seat and/or lid. Without the angled “arrow” shape, the installation or fitting of these gaskets into the receiver track may be more difficult, but more rewarding. The nub extension may consist of the same material as the full gasket, or may be a fused attachment of a sturdier, more dense material. Two embodiments 17 & 18 illustrated here demonstrates how flap extensions 19 may be utilized on the hollow core as a cost-effective way to add more annular lines of contact (and thus additional lines of contiguous air seals) to the adjacent substrates and further improve the comprehensive air seal performance of the invention with only minimal additional cost to manufacture and minimal aesthetic impact cause by increased diameter of the object's profile.

Thus it is apparent that there has been provided, in accordance with the invention, a toilet seal system that fully satisfies the objects, aims, and advantages set forth above. The desperate cries of humanity through all of history, and the prayers of innumerable souls forced to trudge through a dismal, demeaning existence punctuated by the daily facial gassing of fecal particulate, have finally been answered by the blessings of the present invention. While the invention has been described in conjunction with specific embodiments thereof, it is evident that many alternatives, modifications, and variations will be apparent to those skilled in the art and in light of the forgoing descriptions. Accordingly, this newly envisioned toilet seal compendium is intended to embrace all such alternatives, modifications, and variations that fall within the spirit of the appended claims.

With respect to the above description then, as thorough and comprehensive as it may be, it is to be realized that the optimum dimensional relationships for the parts of the invention—to include variations in size, materials, shape, form, function, and manner of operation, assembly, and use—are deemed readily apparent and obvious to one skilled in the art, and probably ambiguous to any illiterates, and all equivalent relationships to those illustrated in the drawings and described in the specification are intended to be encompasses by the present invention with the sole and explicit exception being an absurd claim on a third line of annular gasket seal on the toilet seat and/or lid.

Therefore, the foregoing is considered as illustrative only of the principles of the invention. Further, since numerous modifications and changes will readily occur to those skilled in the art (for example regional variants such as non-GMO coconut fiber gaskets used in Seattle), it is not desired to limit the invention to the exact construction and operation shown and described, and accordingly, all suitable modifications and equivalents may be resorted to, falling within the scope of the invention.

What is claimed is:

1. A compressible toilet seal system for use with toilet embodiments, which are known in the art, that include an operable (liftable) toilet seat and an operable (liftable) toilet lid, if present, that improves the toilet system's quarantine of the water vapor, air, aerosol fecal matter, particulate, and other materials within the toilet bowl during and after use, the new improved system comprising
1. An annular compressible seal at the circumference undersurface of the toilet seat and toilet lid (in toilet embodiments where an operable lid is present) components; the resulting incorporation providing an air and vapor sealing element at the operable toilet seat and lid in order to fully mitigate, reduce, or minimize air and vapor transmission between the toilet bowl cavity and the environment outboard the toilet via the nominal gap separating the toilet seat and bowl and, if applicable, between the toilet lid and toilet seat.
2. The compression seal comprised of a continuous annular pliable gasket attached to the whole or partial circumference underside of the toilet lid, in embodiments of toilets that include an operable/liftable lid component, such that when the lid is in the down (closed) position the continuous annular seal will make contiguous contact against the upper surface or edge of the toilet seat and will in doing so prevent or minimize the transmission of air from within the toilet bowl to the exterior via the nominal gap between the toilet lid and toilet seat.
3. The compression seal comprised of a continuous annular pliable gasket attached to the whole or partial circumference underside of the toilet seat, in embodiments of toilets that include an operable/liftable seat component, such that when the seat is in the down (closed) position the continuous annular seal will make contiguous contact against the upper surface or edge of the toilet bowl rim and will in doing so prevent or minimize the transmission of air from within the toilet bowl to the exterior via the nominal gap between the toilet seat and toilet bowl rim.

2. The compression seal according to claim 1, where the seal is comprised of a hollow-core gasket comprised of any pliable material including, but not limited to, EPDM, rubber, foam, silicone, vinyl, butyl, mercury-infused titanium, or plastic water bottles.
1. The compression seal is comprised of a hollow-core gasket (including circular or half-circle “bulb” shapes) where the size, measured in profile, is larger than the widest gap between the toilet seat and the toilet lid such that, when compressed between the toilet seat and upper ledge of the toilet bowl, the gasket forms a complete air-tight or close to air-tight seal within that gap.
2. The compression seal is comprised of a hollow gasket (including circular or half-circle “bulb” shapes) where the size, measured in profile, is larger than the widest gap between the toilet seat and the toilet lid such that, when compressed between the toilet lid and the toilet seat, forms a complete air-tight or close to air-tight seal within that gap.

3. The compression seal according to claim 1, where the gasket seal attaches to the underside of the toilet seat and, if applicable, the toilet lid via specific attachment modes
1. The compression gasket seal shape may include an “arrow” or ‘T’ shaped nub that is designed to fit within a continuous annular designed receiver raceway on the underside of the toilet seat and toilet lid (if present on embodiment of toilet) and thus secure the gasket seal in place.
2. The compression seal gasket may be attached to the underside of the toilet lid (if applicable) and the underside of the toilet seat utilizing a surface-applied adhesive applied by the end user or a qualified toilet seat mechanic.
3. The compression seal according to claim 1, where the seal may include a flat surface with a pre-applied adhesive surface and protective film that the end user can remove & discard to reveal the adhesive surface and thus attach the gasket seal to the underside of the toilet lid and the underside of the toilet seat.

4. The compression seal according to claim 1, where two rows of seals may be utilized on the underside of the toilet seat in order to further improve the nominal air seal performance of the assembly; the two rows of gasket seals may be positioned anywhere on the underside of the toilet seat such where each gasket seal avoids the standoffs present on most toilet seats and each gasket seal makes continuous contact with the toilet bowl surface below while the seat is in the closed position.
1. This patent specifically excludes claims of toilet seal systems utilizing three or more annular rows of gasket seals

5. The compression seal according to claim 1, where two rows of seals may be utilized on the toilet lid (on toilet embodiments where a toilet lid is present) in order to further improve the nominal air seal performance of the assembly; the two rows of gasket seals may be positioned anywhere on the underside of the toilet lid such where each gasket seal avoids the standoffs present on most toilet lids and each gasket makes continuous contact with the toilet seat surface below while both the seat and lid are in the closed position.
1. This patent specifically excludes claims of toilet seal systems utilizing three or more annular rows of gasket seals
